(19) United States
(12) Patent Application Publication
(10) Pub. No.: US 2007/0177064 A1
(43) Pub. Date: Aug. 2, 2007

(54) Antenna and supporting structure thereof

(75) Inventors: Hung Yuan Lin, Taipei (TW); San Yi Kuo, Taipei (TW)

Correspondence Address: QUINTERO LAW OFFICE, PC, 2210 MAIN STREET, SUITE 200, SANTA MONICA, CA, 90405, US

(73) Assignee: WISTRON NEWEB CORP., TAIPEI HSIEN (TW)

(21) Appl. No.: 11/484,235

(22) Filed: Jul. 10, 2006

(30) Foreign Application Priority Data
Jan. 27, 2006 (TW) TW95103452

(51) Int. Cl. H04N 5/64

(52) U.S. Cl. 348/838

(57) ABSTRACT

A supporting structure comprises a base, a moveable unit and a first fine-tuning unit. The base comprises a body, a shaft, a first pivoting portion and a first groove, wherein the first pivoting portion and the first groove are disposed on the body. The moveable unit comprises a second pivoting portion and a positioning element, wherein the shaft passes the first and second pivoting portions to connect the moveable unit and the base, and the positioning element passes the first groove to position the moveable unit on the base. The first fine-tuning unit connects the base and the moveable unit, wherein the first fine-tuning unit rotates the moveable unit relative to the base.

### BACKGROUND OF THE INVENTION

1. Field of the Invention

The invention relates to a supporting structure, and in particular to a supporting structure for adjusting elevation angle.

2. Description of the Related Art

FIG. 1 shows a conventional antenna 1 for receiving signals from satellite, comprising a dish 2, a down converter 3 and a supporting structure 4. The supporting structure 4 connects the dish 2 via a pivoting portion 5.

The dish 2 pivots on the pivoting portion 5 to adjust elevation angle thereof. However, when the dish 2 is pivoted, the weight of the dish 2 and the down converter 3 must be countered. Thus, it is difficult to accurately adjust the elevation angle of the dish 2.

Recently, KA band signals utilized for transmitting data with a smaller antenna radiation lobe bandwidth are more sensitive to dish misalignment. Conventionally, there is no accurate fine-tuning mechanism for adjusting the elevation angle of dish. Thus, adjusting time is increased and signal reception compromised.

### BRIEF SUMMARY OF THE INVENTION

A detailed description is given in the following embodiments with reference to the accompanying drawings.

The invention provides a supporting structure comprising a base, a moveable unit and a first fine-tuning unit. The base comprises a body, a shaft, a first pivoting portion and a first groove, wherein the first pivoting portion and the first groove are disposed on the body. The moveable unit comprises a second pivoting portion and a positioning element, wherein the shaft passes the first and second pivoting portions to connect the moveable unit and the base, and the positioning element passes the first groove to position the moveable unit on the base. The first fine-tuning unit connects the base and the moveable unit, wherein the first fine-tuning unit rotates the moveable unit relative to the base.

The invention further provides a supporting structure comprising a second fine-tuning unit connecting the base and the seat, wherein the second fine-tuning unit impels the base to rotate the base relative to the seat.

The supporting structure of the invention can precisely adjust the elevation angle of the antenna to improve transmission thereof. Additionally, the supporting structure of the invention can be fast-tuned and fine-tuned with a simple structure, for improved convenience.

### BRIEF DESCRIPTION OF THE DRAWINGS

The invention can be more fully understood by reading the subsequent detailed description and examples with references made to the accompanying drawings, wherein:

FIG. 1 shows a conventional antenna:

FIG. 2 shows an antenna of the invention;

FIG. 3 is an exploded view of a supporting structure of the invention;

FIG. 4a shows detailed structures of a fine-tuning rod and a second fixing element of the invention;

FIG. 4b shows a detailed structure of a first section;

FIG. 5 is an assembly view of the supporting structure;

FIGS. 6a˜6d show an elevation angle adjusting process of the invention;

FIGS. 7a˜7b show a supporting structure of a modified embodiment of the invention.

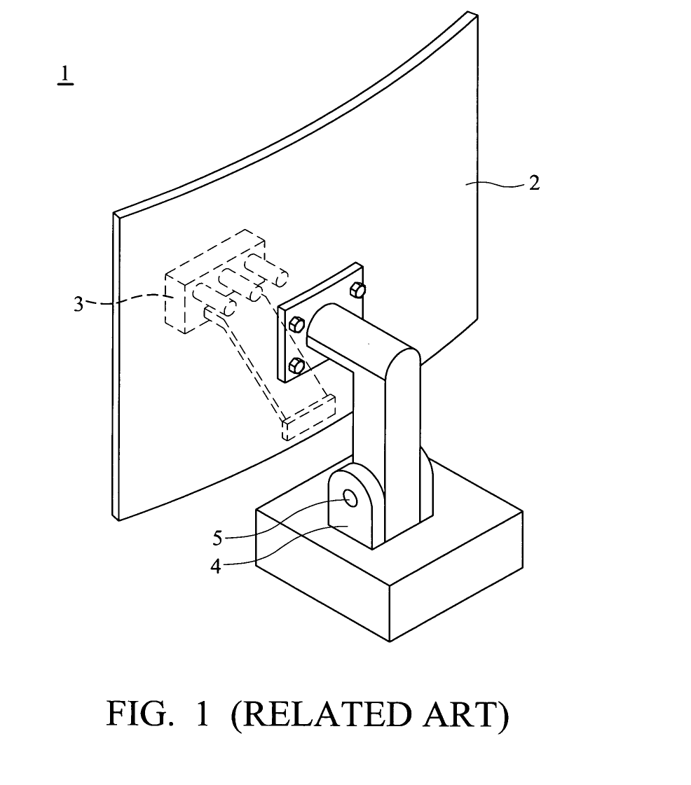

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

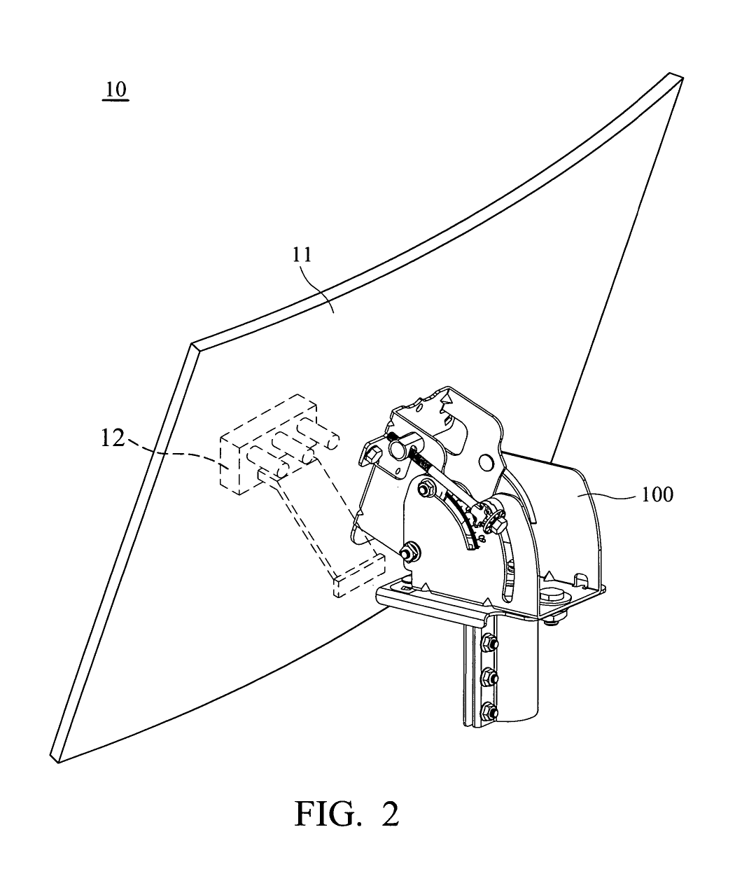

FIG. 2 shows an antenna 10 of the invention comprising a dish 11, a down converter 12 and a supporting structure 100. The dish 11 is disposed on the supporting structure 100, and the down converter 12 corresponds to the dish 11. The supporting structure 100 of the invention can be fine-tuned to accurately control elevation angle of the dish 11.

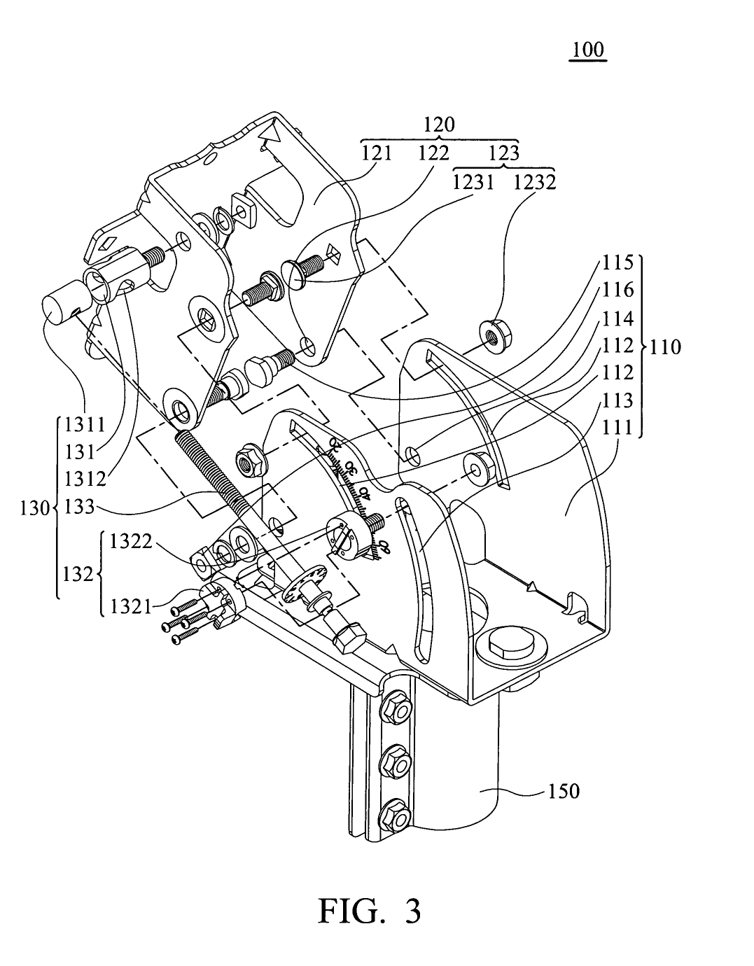

FIG. 3 is an exploded view of the supporting structure 100 of the invention, which comprises a base 110, a moveable unit 120, a fine-tuning unit (first fine-tuning unit) 130 and a seat 150. The base 110 horizontally pivots on the seat 150 comprising a body 111, first grooves 112, a second groove 113, first pivoting portions 114, shafts 115 and nuts 116. The first grooves 112, the second groove 113 and the first pivoting portions 114 are disposed on the body 111. The first pivoting portions 114 comprise through holes. The shafts 115 are bolts corresponding to the nuts 116. The moveable unit 110 comprises a frame 121, second pivoting portions 122 and positioning elements 120. The second pivoting portions 122 comprise through holes formed on the frame 121. The shafts 115 pass the first pivoting portions 114 and the second pivoting portions 122 to connect the moveable unit 120 and the base 110. The positioning elements 123 comprise bolts 1231 and nuts 1232 disposed in the first grooves 112 to position the moveable unit 120 relative to the base 110. The fine-tuning unit 130 comprises a first fixing element 131, a second fixing element 132 and a fine-tuning rod 133. The first fixing element 131 is disposed on the frame 121 comprising a rotation element 1311 and an opening 1312. The rotation element 1311 is rotatably disposed in the first fixing element 131. The opening 1312 is formed on the first fixing element 131. The fine-tuning rod 133 is connected to the rotation element 1311, passing the rotation element 1311 and the opening 1312, and moveable in the opening 1312. The second fixing element 132 is disposed in the second groove 113 comprising a first section 1321 and a second section 1322. The first section 1321 and the second section 1322 are connected and abut the fine-turning rod 133.

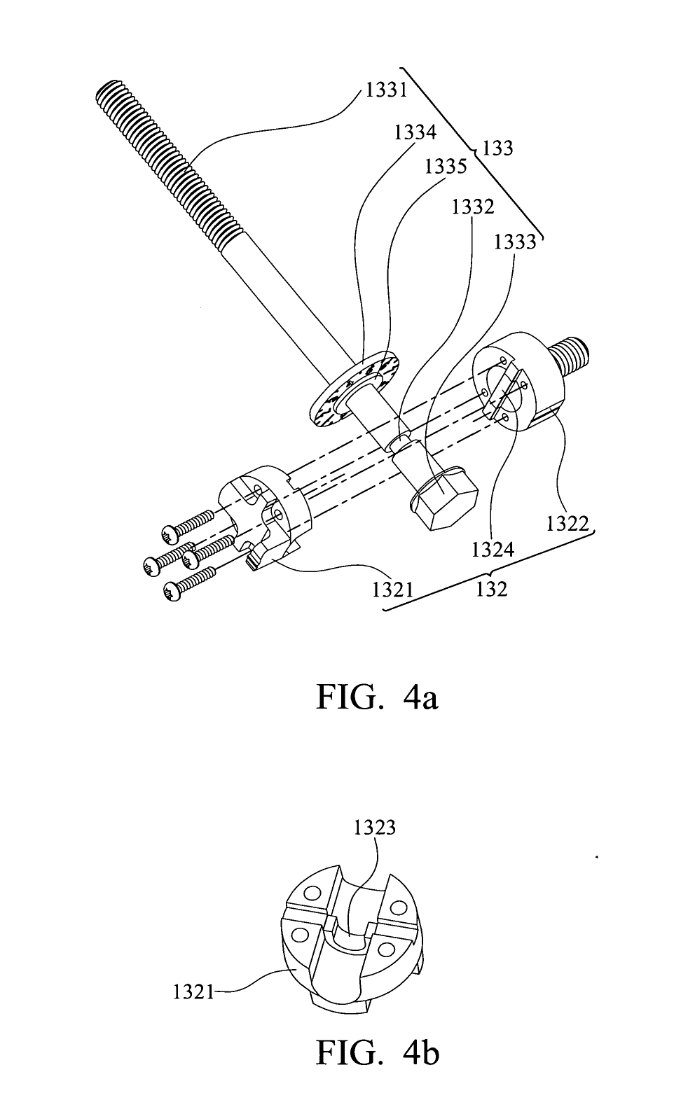

FIG. 4a shows detailed structures of the fine-tuning rod 133 and the second fixing element 132. The fine-tuning rod 133 comprises a thread 1331, a notch 1332 (a third abutting portion), a holding portion 1333, a dial 1334 and an O-ring 1335. The thread 1331 is formed on an end of the fine-tuning rod 133. The notch 1332 surrounds the fine-tuning rod 133. The dial 1334 and the O-ring 1335 are disposed on the fine-tuning rod 133. The O-ring 1335 contacts the dial 1334 to increase friction between the dial 1334 and the fine-tuning rod 133. The holding portion 1333 is disposed on another end of the fine-tuning rod 133. With reference to FIG. 4b, the first section 1321 comprises a first abutting portion 1323 which is a protrusion. The second section 1322 comprises a second abutting portion 1324 which is a protrusion. When the first section 1321 and the second section 1322 are assembled, the first abutting portion 1323 and the second abutting portion 1324 are inserted into the notch 1332 (the third abutting portion). Thus, the second fixing element 132 abuts the fine-tuning rod 133.

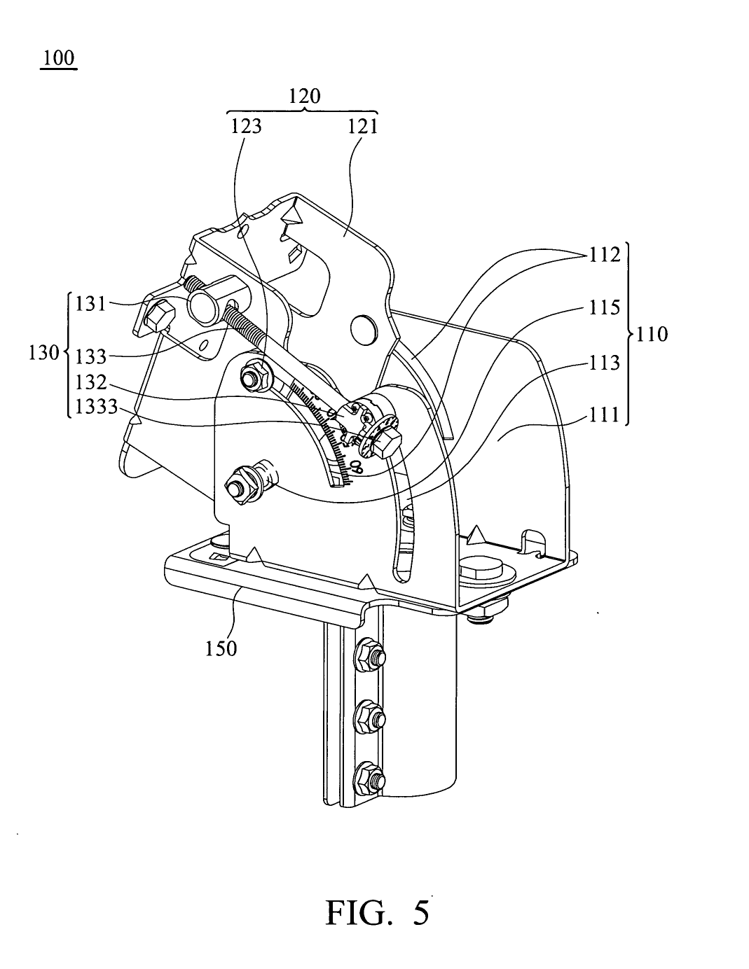

FIG. 5 is an assembly view of the supporting structure 100, wherein the O-ring (not shown) is sandwiched between the holding portion 1333 and the dial 1334. Thus, the dial 1334 is rotated with the fine-tuning rod 133. Additionally, at least one wear-resisting sheet (not shown) is disposed between the moveable unit 120 and the base 110 to reduce friction therebetween. In a modified embodiment, the wear-resisting sheet is disposed around the positioning elements 123 and the shafts 115 to improve fine-tuning accuracy. An angle mark is formed near the first groove 112.

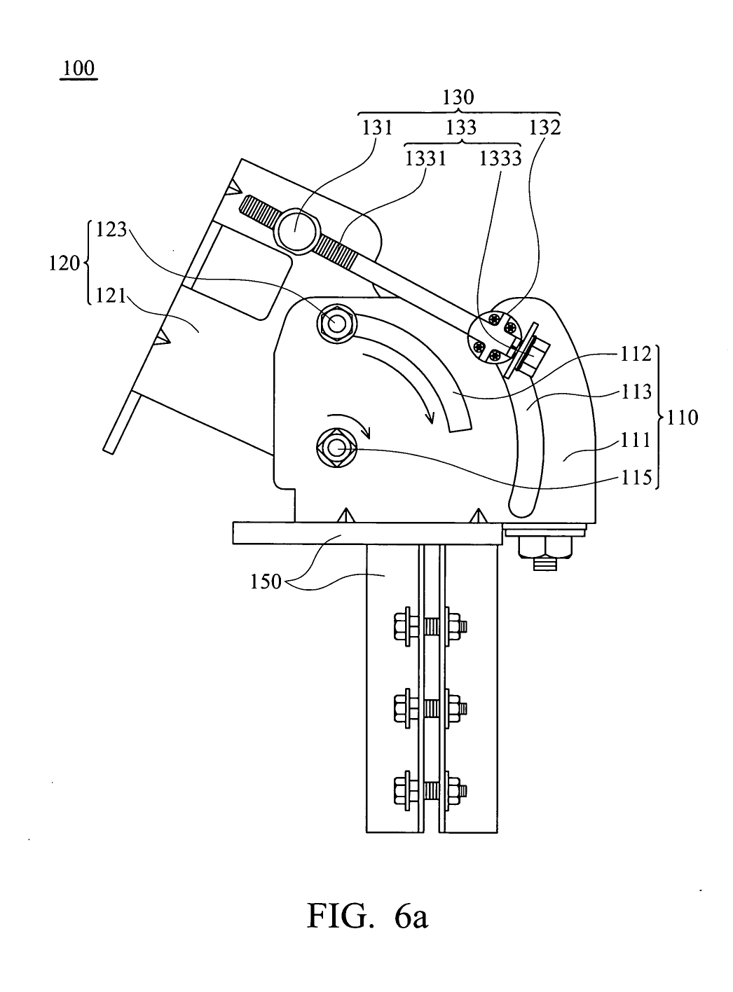

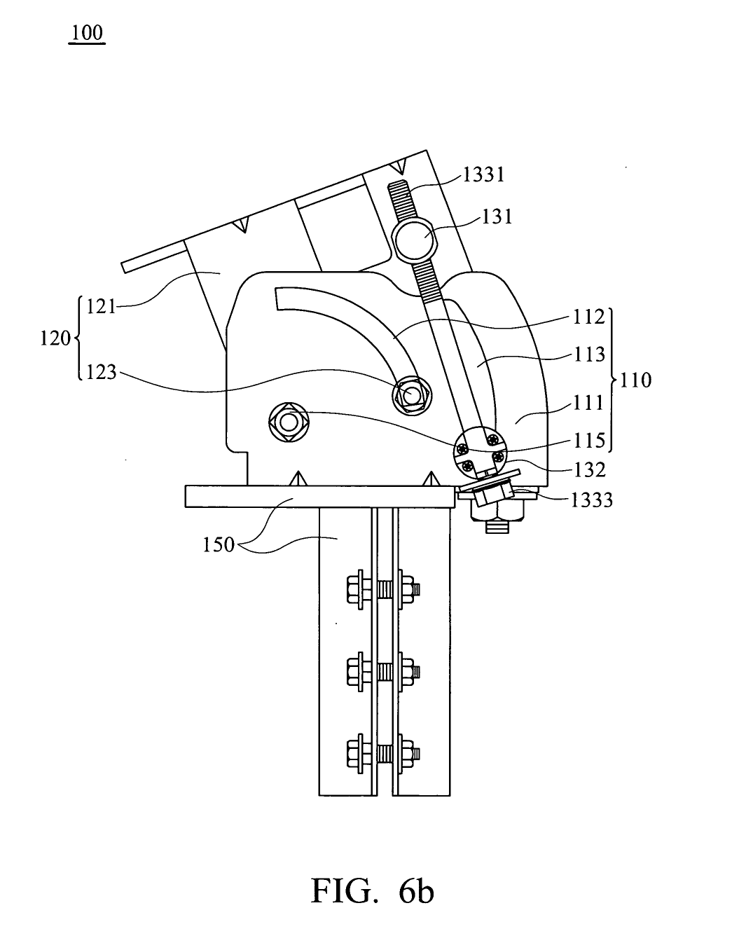

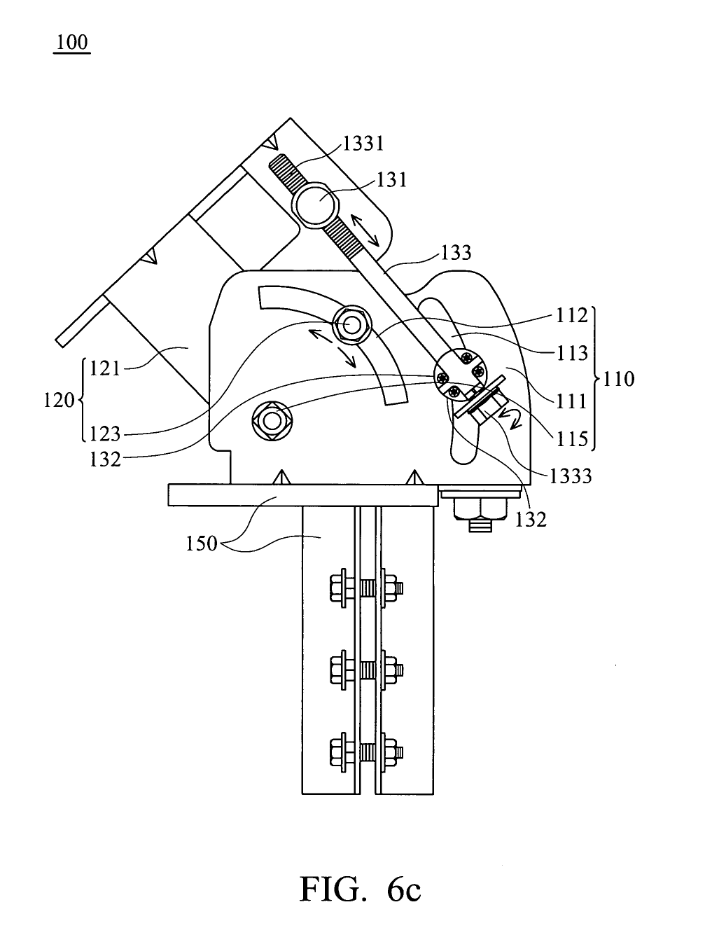

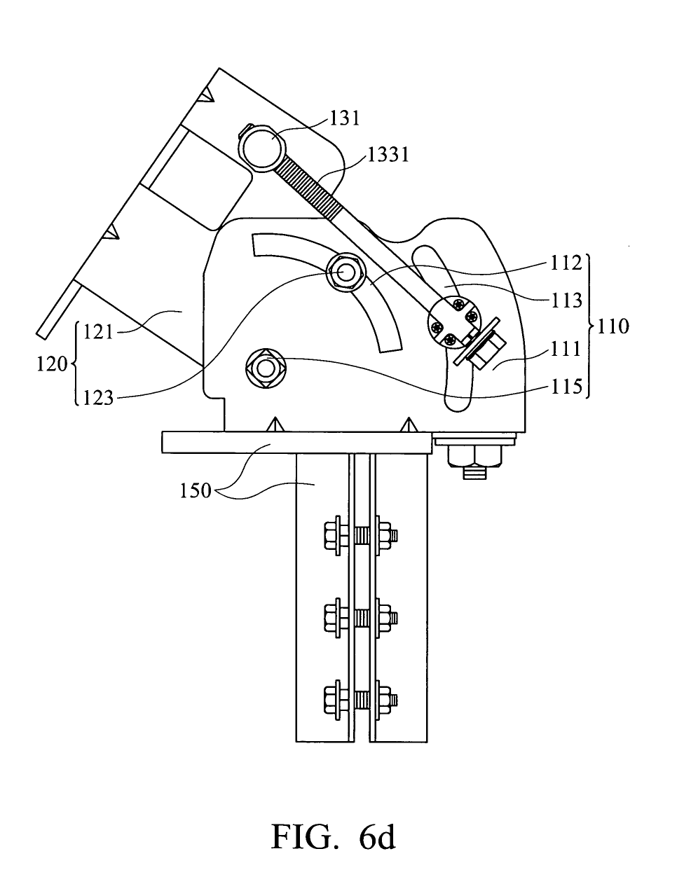

The elevation angle adjusting process is described with side views of the supporting structure 100. With reference to FIG. 6a, first, the positioning elements 123 are moveably disposed in the first grooves 112, and the second fixing element 132 is moveably disposed in the second groove 113, wherein the first fixing element 131 is located in a middle portion of the thread 1331. The moveable unit 120 can be rotated around the shafts 115 to adjust the elevation angle of the moveable unit 120. For example, with reference to FIG. 6b, the moveable unit 120 is rotated from the orientation in FIG. 6a to the orientation in FIG. 6b to improve signal transmission. With reference to FIG. 6c, after the moveable unit 120 is rotated to a desired elevation angle, the second fixing element 132 is fixed in the second groove 113. Then, the holding portion 1333 is rotated to modify the position of the first fixing element 131 relative to the fine-tuning rod 133 to fine-tune the elevation angle of the moveable unit 120. Finally, with reference to FIG. 6d, after the moveable unit 120 is rotated to a desired elevation angle, the positioning elements 123 are fixed in the first grooves 112.

The supporting structure of the invention can precisely adjust the elevation angle of the antenna to improve transmission thereof. Additionally, the supporting structure of the invention can be fast-tuned and fine-tuned with a simple structure, for improved convenience.

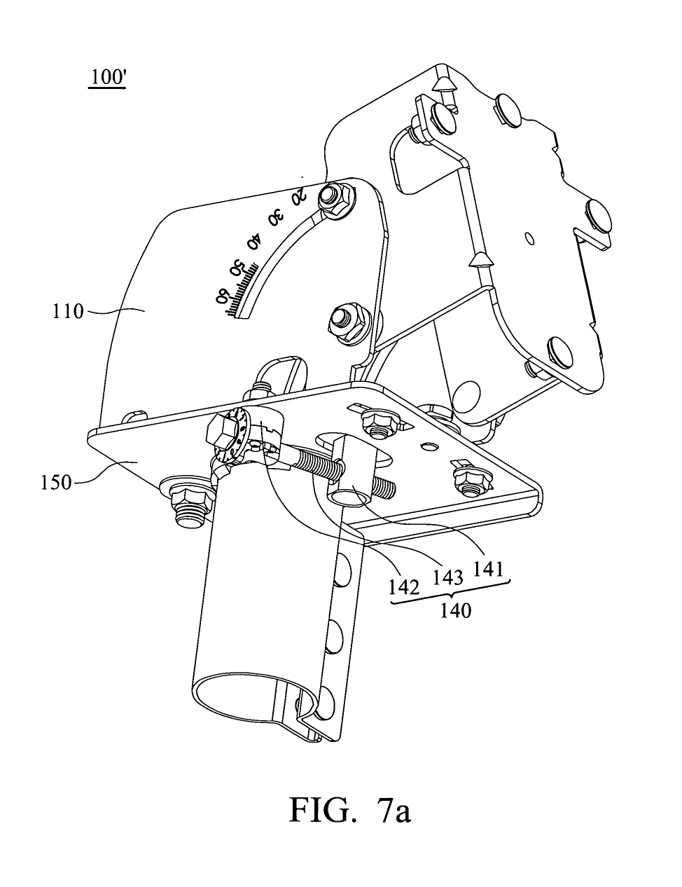

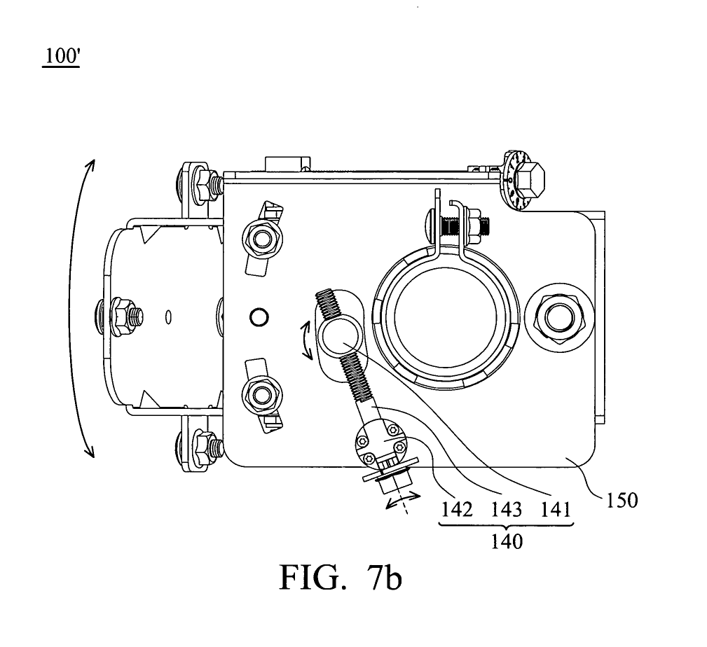

FIG. 7a shows a supporting structure 100' of a modified embodiment of the invention comprising a second fine-tuning unit 140 disposed between the base 110 and the seat 150 to adjust a horizontal orientation of the supporting structure 100'. The second fine-tuning unit 140 is similar to the first fine-tuning unit 130 comprising a third fixing element 141, a fourth fixing element 142 and a fine-tuning rod 143. The third fixing element 141 is fixed on the base 110. The fourth fixing element 142 is fixed on the seat 150. With reference to FIG. 7b, the horizontal orientation of the base 110 relative to the seat 150 is adjusted by rotating the fine-tuning rod 143.

While the invention has been described by way of example and in terms of a few embodiments, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A supporting structure, comprising:
a base, comprising a body, a shaft, a first pivoting portion and a first groove, wherein the first pivoting portion and the first groove are disposed on the body;
a moveable unit, comprising a second pivoting portion and a positioning element, wherein the shaft passes the first and second pivoting portions to connect the moveable unit and the base, and the positioning element passes the first groove to position the moveable unit on the base; and
a first fine-tuning unit, connecting the base and the moveable unit, wherein the first fine-tuning unit rotates the moveable unit relative to the base.

2. The supporting structure as claimed in claim 1, wherein the first fine-tuning unit changes a rotation movement to a displacement to impel the moveable unit to rotate the moveable unit relative to the base.

3. The supporting structure as claimed in claim 1, wherein the base further comprises a second groove disposed on the body.

4. The supporting structure as claimed in claim 3, wherein the first fine-tuning unit comprises a first fixing element, a fine-tuning rod and a second fixing element, the first fixing element is fixed to the moveable unit, the second fixing element is disposed in the second groove, and the fine-tuning rod connects the first and second fixing element.

5. The supporting structure as claimed in claim 4, wherein the fine-tuning rod comprises a thread disposed on an end thereof to connect the first fixing element.

6. The supporting structure as claimed in claim 4, wherein the first fixing element comprises a rotatable element, rotatably disposed in the first fixing element and connected to the fine-tuning rod.

7. The supporting structure as claimed in claim 4, wherein the second fixing element abuts the fine-tuning rod.

8. The supporting structure as claimed in claim 7, wherein the second fixing element comprises a first section and a second section, the first section comprises a first abutting portion, the second section comprises a second abutting portion, the fine-tuning rod comprises a third abutting portion, and the first and second abutting portion abut the third abutting portion.

9. The supporting structure as claimed in claim 8, wherein the first abutting portion is a protrusion.

10. The supporting structure as claimed in claim 9, wherein the second abutting portion is a protrusion.

11. The supporting structure as claimed in claim 10, wherein the third abutting portion is a notch, the first and second abutting portions are inserted into the third abutting portion.

12. The supporting structure as claimed in claim 4, wherein the first fine-tuning unit further comprises a dial and an O-ring disposed on the fine-tuning rod, and the O-ring contacts the dial.

13. The supporting structure as claimed in claim 1, further comprising at least one wear-resisting sheet disposed between the base and the moveable unit to reduce friction therebetween.

14. The supporting structure as claimed in claim 1, further comprising a seat. wherein the base is rotatably disposed on the seat.

15. The supporting structure as claimed in claim 14, further comprising a second fine-tuning unit connecting the base and the seat, wherein the second fine-tuning unit impels the base to rotate the base relative to the seat.

16. A supporting structure, comprising:
a seat;
a base, rotatably disposed on the seat; and
a second fine-tuning unit connecting the base and the seat, wherein the second fine-tuning unit impels the base to rotate the base relative to the seat.

17. An antenna, comprising:
a base, comprising a body, a shaft, a first pivoting portion and a first groove, wherein the first pivoting portion and the first groove are disposed on the body;
a moveable unit, comprising a second pivoting portion and a positioning element, wherein the shaft passes the first and second pivoting portions to connect the moveable unit and the base, and the positioning element passes the first groove to position the moveable unit on the base;
a first fine-tuning unit, connecting the base and the moveable unit, wherein the first fine-tuning unit rotates the moveable unit relative to the base;
a dish, disposed on the moveable unit; and
a down converter, corresponding to the dish.

18. The antenna as claimed in claim 17, further comprising a seat, wherein the base is rotatably disposed on the seat.

19. The antenna as claimed in claim 18, further comprising a second fine-tuning unit connecting the base and the seat, wherein the second fine-tuning unit impels the base to rotate the base relative to the seat.
